(19) United States
(12) Patent Application Publication
(10) Pub. No.: US 2013/0014468 A1
(43) Pub. Date: Jan. 17, 2013

(54) RESTORATION METHODS FOR STRUCTURAL COMPONENTS

(71) Applicant: Mohammad R. Ehsani, Tucson, AZ (US)

(72) Inventor: Mohammad R. Ehsani, Tucson, AZ (US)

(21) Appl. No.: 13/439,722

(22) Filed: Apr. 4, 2012

Related U.S. Application Data
(60) Provisional application No. 61/572,245, filed on Jul. 14, 2011.

(51) Int. Cl. E04G 23/02; B29C 67/24; B29C 69/00; E04B 1/92

(52) U.S. Cl. 52/741.3; 264/239; 264/261

(57) ABSTRACT

A method and an article of manufacture are disclosed for externally reinforcing various solid structures, such as columns, poles, piles, beams, pipes and the like, constructed from various materials. Pre-preg and pre-cured reinforcement sheets with high tensile strength fabric core and with desired rigidity and elasticity are wrapped around structural elements, forming an external reinforcement shell with a space between the structural element and the shell, where the space will be filled with materials such as concrete, grout, epoxy, or other similar reinforcing material. In various embodiments, a surface groove is created in the solid structure and a reinforcing bar (rebar) is embedded in the groove to further structurally bond the solid structure to the reinforcing material poured in the space created between the structural element and the shell.

### CROSS-REFERENCE(S) TO RELATED APPLICATION(S)

This non-provisional application is related to U.S. Provisional Patent Applications No. 61/572,245 filed on 14 Jul. 2011, and to U.S. Utility patent application Ser. No. 13/409,688, filed on 1 Mar. 2012, the benefit of the priority date of which Provisional Application is hereby claimed under 35 U.S.C. §119(e).

### TECHNICAL FIELD

This application relates generally to construction. More specifically, this application relates to a method and apparatus for externally reinforcing structures with a structure reinforcement wrap (hereinafter, “SRW”).

### BRIEF DESCRIPTION OF THE DRAWINGS

The drawings, when considered in connection with the following description, are presented for the purpose of facilitating an understanding of the subject matter sought to be protected.

FIGS. 1A-1D show example structures suitable to be reinforced with reinforcement wrap;

FIG. 2A shows an example deteriorated column reinforcement using a shell made from structure reinforcement wrap (SRW) and added rebar;

FIG. 2B shows an example column reinforcement using multiple shell segments made from SRW;

FIG. 3 shows another example column reinforcement using multiple shell segments made from SRW; and

FIG. 4 shows an example process of reinforcing a column using SRW.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Briefly described, a method and an article of manufacture are disclosed for externally reinforcing various rigid structures, such as columns, poles, piles, beams, pipes, and the like, constructed from various materials including, but not limited to steel, concrete, masonry, wood, plastics, and the like. Some of the various structures may be used to support buildings, bridges, floors, utility and electrical power lines and the like; others can be hollow such as pipes or chimneys, etc. As a part of the disclosed reinforcement process, one or multiple layers of a novel reinforcement sheet may be wrapped around a surface of a structure to form an external shell. The one or multiple layers of reinforcement sheets constitute a structure reinforcement wrap (SRW), which is elastically flexible but stiff, providing structural strength in the hoop direction, the longitudinal direction, or in random directions, and is usable under tension or compression loads. Each elastically deformable reinforcement sheet may be pre-formed such as in the form of a semi cylinder with a predetermined curvature, or other geometric or non-geometric custom shapes.

In some embodiments the reinforcement sheets are manufactured using pre-cured Fiber Reinforced Polymer (FRP) layers saturated with resin or epoxy or the like. Such reinforcement sheets have elasticity properties similar to a sheet metal and can be formed into, for example, a cylinder surrounding a column by bringing and attaching their opposite edges together. Because these reinforcement sheets hold their manufactured shapes, it is easy to hold them in place and there is no need to use a spacer either between their overlapping layers or between the reinforcement sheets and the structures within them.

The space between an SRW and the structure within it may be filled with concrete, grout, epoxy, or other similar reinforcing material. The SRW and the filler materials thus form a solid reinforcement shell around the structure, such as column or pipe, to reinforce the structure for bearing static and dynamic loads. Such loads include static weight, impact load, blast load, earthquakes, moving vehicle loads, wind load, fluid pressure and the like. In various embodiments, a groove is created in a solid structure and a reinforcing bar (rebar) is embedded in the groove to further structurally bond the solid structure to the concrete poured in the planar space created by the between the SRW and the damaged structure. In other embodiments reinforcing bar (rebar) is merely placed in the space created by the SRW and the structure before filling the space with concrete, grout, epoxy, or other similar reinforcing material. Such bars improve the axial, bending, and shear strength of the solid structure.

Structural repair can be expensive, cumbersome, and time consuming. Structures can get damaged due to a variety of factors, such as earthquakes, overloading, weight of traffic, wear and tear, corrosion, explosions, and the like. Prevention is generally more cost-effective than repairs. As such, it is generally easier and more cost-effective to strengthen a structure that may be exposed to damaging forces and loads, than waiting to repair such eventual damages after they occur or to replace the structure with a new one. Intentional damage inflicted upon infrastructure, by terrorism or vandalism, is another way that structural damage may result. For example, recently, there has been growing interest to strengthen the above-mentioned structures for blast loading, such as terrorist attacks, which may seek to blow up a building, a bridge, a pipe and the like, by placing a bomb adjacent to the structure and detonating it. In addition to prevention, if damage does occur to a structure, a cost-effective and speedy method of repair is clearly desirable.

One of the problems with existing structural support components such as columns, piles, poles, and pipes is that they are subject to corrosion that weakens these structures. Since these support structures may be submerged in water or be buried in soil, it is more cost-effective and thus preferred to repair them without using expensive diving gear and complex underwater procedure or digging trenches in the ground to access the repair area. The latter could potentially damage pipes, cables and other structures and utilities that are buried near the support structure. Often, these support components are subjected to traffic, wind, and weight loads. Thus, a repair material and method should not only provide protection against corrosion, but also provide additional strength for the support component.

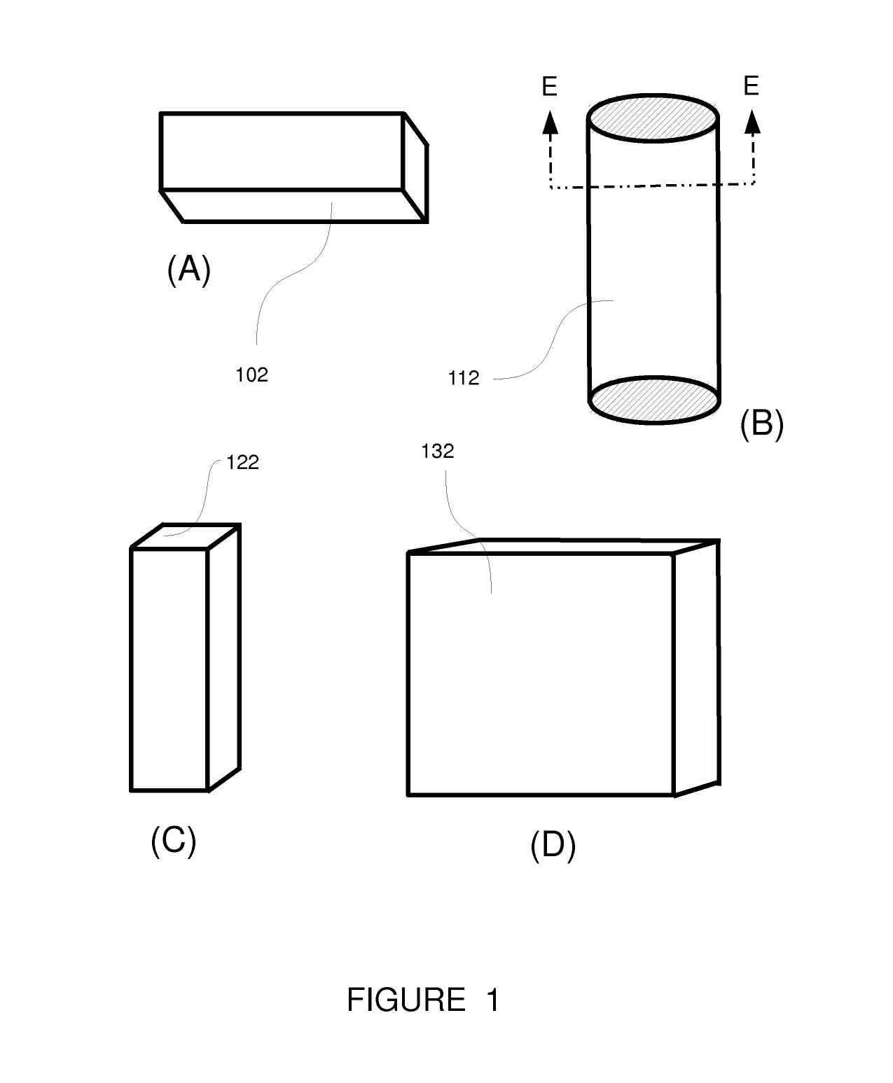

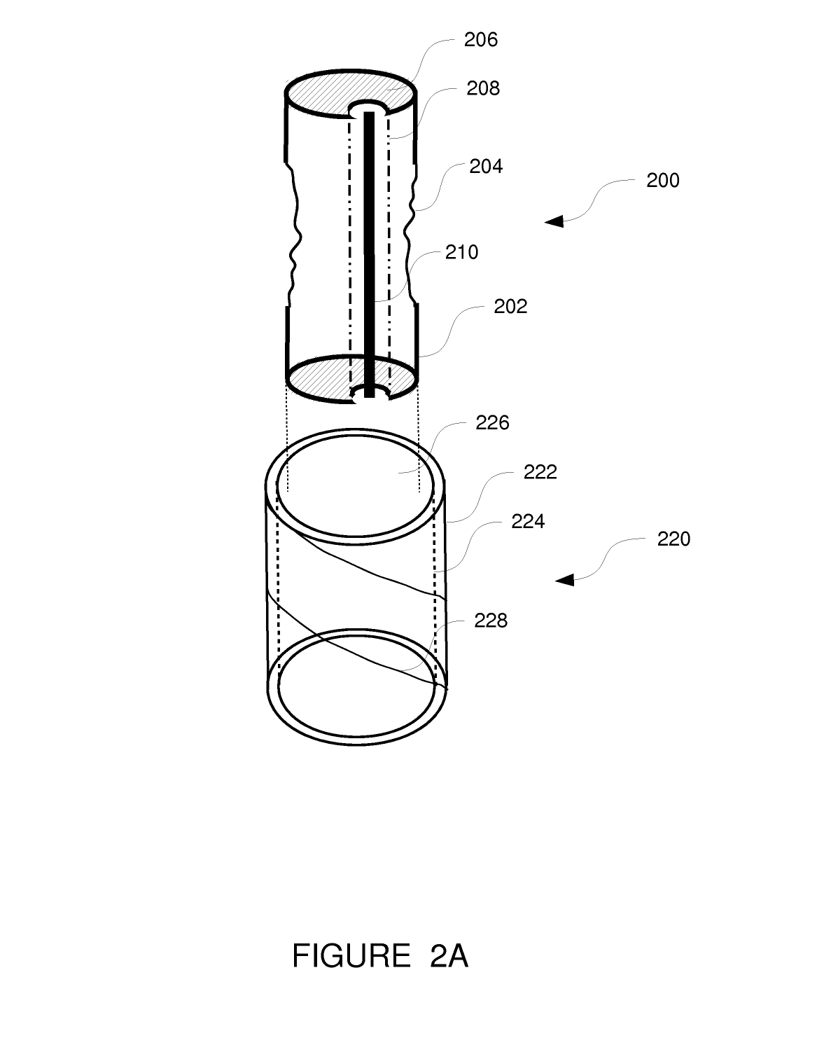

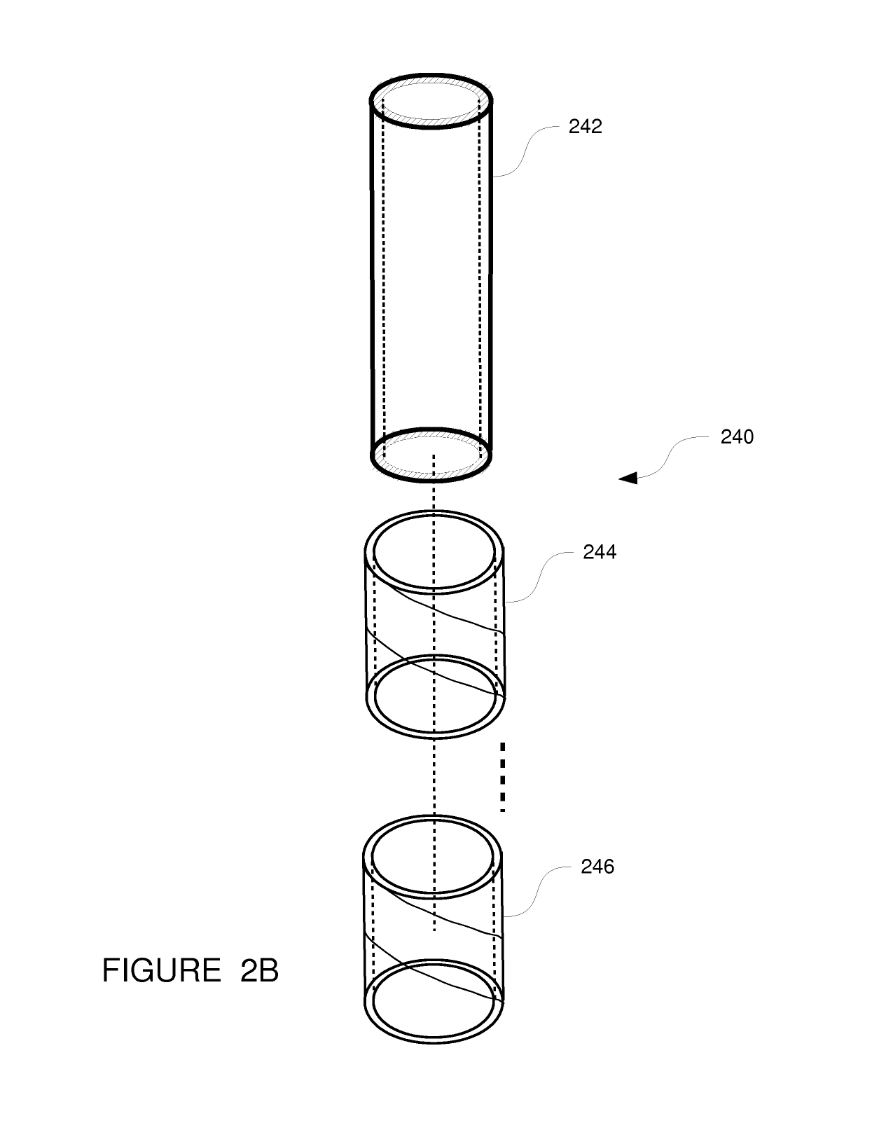

FIGS. 1A-1D show example structures suitable to be reinforced with disclosed reinforcement sheets. FIG. 1A shows a beam 102 in a horizontal position, while FIG. 1B shows cylindrical structure 112, such as a column, a pole, a pile, a chimney, and the like; however, these structures may not be cylindrical. A section E-E of FIG. 1B is shown in greater detail in FIGS. 2A and 2B. FIGS. 1C and 1D show structures 122 and 132 with rectangular cross-sections, such as walls and square or rectangular columns. FIG. 2B shows a hollow structure 242 that can have a cylindrical or oval shape cross section, such as a pipe. Any of these structures may be reinforced by external shells constructed using disclosed reinforcement sheets.

Structures of relatively smaller sizes and accessible configurations, such as columns, may be wrapped with disclosed reinforcement sheets, while relatively larger and/or inaccessible structures such as walls, entire buildings, and the like may be augmented with external shells made from reinforcement sheet laminates on their surfaces, which may be exposed to potentially damaging loading. Those skilled in the art will appreciate that the structure to be reinforced may have any cross sectional shape in addition to round and rectangular, such as triangular, oval, polygonal, irregular, H- and W-shaped steel sections and the like.

FIG. 2A shows an example deteriorated column reinforcement using a shell made from disclosed reinforcement sheets and added rebar. In various embodiments, reinforcement arrangement 200 includes a structure, such as column 202, having a deteriorated section 204 and an interior 206. For additional reinforcement and/or repair, groove 208 is created near the surface of column 202 and rebar 210 is deployed within groove 208. External reinforcement shell 220 includes an outer reinforcement layer 222, which forms an inner space layer 224, a hollow interior 226, and spiral seams 228 formed by spirally wrapping layer 222 to form the shell. The reinforcement wrapping may be cylindrical instead of or in addition to the spiral.

The construction of shell 220 around the structure to be reinforced, such as a column, includes wrapping one or more pre-saturated (for example by resin or epoxy) and pre-cured reinforcement sheet, typically about 1-3 feet wide, around the column. The reinforcement sheets may be held in a wrapped position by gluing together their overlapping edges. For shells longer or taller than the width of the reinforcement sheets, the sheets are wrapped around the column in a butt-joint or overlapping fashion or in an overlapping spiral fashion to extend the length of the shell beyond the width of such sheets. The overlap of the spiral wrapping sheets seals the shell and adds to its strength.

Next, the space created between the SRW and the column is filled with a reinforcing material such as resin, epoxy, grout, concrete, polymer modified concrete, and the like. In some embodiments, the wrapping of the SRW reinforcement sheets may not be a spiral wrapping at an angle, but a complete overlap of the reinforcement sheet edges at 0 degree angle.

In various embodiments, prior to forming external reinforcement shell 220 around the column, surface grooves 208 may be cut along the height of the column or wooden pile and reinforcing steel bars (rebars) may be inserted in those grooves. In such embodiments, when the space between the SRW layer and the column is filled with reinforcement material such as grout or resin, the rebars are covered with the material and further help bond the shell to the column and further strengthen the column against both axial and bending stresses.

In some embodiments steel shear studs are welded or bolted to the surface of a steel column and the space between the reinforcement shell and the column is filled with grout or other filler material. Vertical rebars may also be added in this space for additional strength.

FIG. 2B shows an example column reinforcement using multiple shell segments made from SRW. In various embodiments, a solid structure, such as column or a hollow structure such as a pipe 242, is reinforced using multiple external reinforcement shell segments 244, 246, each shell segment constructed in a manner similar to that described above with respect to FIG. 2A. Any two overlapping reinforcement shell segments may be adhesively attached to each other.

Concrete, steel & timber columns, utility poles, and underwater piles, other similar support structures often need to be repaired or strengthened due to deterioration over time or damage caused by events such as floods, earthquakes, and accidents. Generally, the repair necessitates the worker to be at a working position adjacent to and at the same elevation or point as the damaged area of the column or pile. To provide such proximity to damaged area, it is necessary to have access to the damaged area. When the damaged area of the pole or column is below ground or under water, such access substantially increases the repair cost due to the need for special equipment and skills and also due to the working conditions and procedures.

To repair and/or to reinforce such damage areas without direct access, in some embodiments, a number of sufficiently stiff or rigid shells which can hold their shape and can be moved away from the working position, up or down, along a column (or left and right along a pipe) are employed. This extended shell may be lowered to an elevation below (or above) the workers constructing the shell segments. For example, if the workers are working on a barge to repair a pile in water, the finished portion of the shell can be pushed down under the water surface without requiring divers or underwater equipment. The above procedures may be repeated until a sufficiently tall shell has been created to enclose the desired (or damaged) portion of the pile. The space between such a shell and the damaged or host column may be filled with a reinforcing material to bond the shell to the host column and make the column and the shell work together against loading stresses.

As previously mentioned each reinforcement sheet may be pre-cured to hold a different shape in its undisturbed state. For example a reinforcement sheet may be cured on a semi-cylinder of 2-feet radius to simplify rolling it for transportation or forming it into a cylinder around a structure.

For under water applications, the bottom of the space between the shell and the pile is sealed to prevent reinforcing material from escaping the space between the reinforcement shell and the structure and to prevent water from seeping in and corroding or causing further damage to the pile's base. Sealing may be done in various ways, such as by using an inflated bladder like a bicycle tube or Oakum rope, or by having a built-in edge or lip at the bottom of the first sheet, or stiff plates that are supported by cables attached to the upper portions of the pile. Next, the space between the shell and the pile is filled with a reinforcing material such as resin, grout, concrete, polymer, modified concrete, or special underwater grouts, a resin that has been mixed with sand or other filler materials to reduce the unit cost per volume. The reinforcing material bonds the external shell to the host column or pile and prevents moisture and oxygen to enter into the enclosed area and corrode the reinforcing bars or decay the concrete.

The outer surface of the reinforcement shell may be painted to protect it from environment and/or to provide a more aesthetic appearance. Such painting may also be performed in a step by step manner on each piece of the finished shell segment above waterline before it is pushed down into water.

In various embodiments, the reinforcement sheets core fabric may be pre-saturated (referred to in the industry as “pre-preg”) with a resin. The pre-saturated fabric is laid over a jig and is activated to start to cure and harden. The resin may be activated to start curing using various methods, such as by exposure to UV light, such as natural sunlight. This procedure makes the installation easier because the workers do not have to saturate the core fabric with resin in the field, although, the same process may be used to manufacture reinforcement sheets in the field and use them after they are partially or completely cured and gained desired stiffness to hold their shapes. Such reinforcement sheets and resulting SRW's create hard and stiff shells that may be sent down into water, or below ground for repair of utility poles, bridge columns, and the like. If there is not sufficient sunlight, special UV lights may be used to accelerate the curing of the resin.

The procedure described above may be used for the repair of utility poles or bridge piers below grade and extending to regions above grade. Once the shell is created above ground as described earlier, the stiff shell may be lowered below grade. To do this, a small space may be cut around the pole in soil using various methods such as using a high pressure water jet (such as commercially available pressure washers with a longer nozzle attached) or high pressure air. Once the space is created, the stiff shell is lowered into ground to its final position. The earth at the base can be used to create a seal at the bottom of the shell. Then the space is filled with resin or grout or any combination described above.

It should be understood that if the dimensions of a single reinforcement sheet are such that it cannot completely surround the circumference of a structural element, two or more reinforcement sheets may be attached together, for example by overlapping and gluing their edges, to form a larger reinforcement sheet that can cover the circumference of the structural element.

In some embodiments the core fabric of reinforcement sheets are woven strands of high tensile strength. The weaving may be an orthogonal weaving, such as the customary clothing fabrics, or other types of weavings. In other embodiments the fabric strands may not be woven, but simply laid over each other or side by side, or both, in one or multiple directions and joined together by a bonding medium such as resin, nylon, or plastic.

In various embodiments, the reinforcement sheet is constructed from fiber-reinforced material, such as Fiber Reinforced Polymer (FRP) to give the sheets more resistance against various types of loading, such as blast loading. Those skilled in the art will appreciate that many types of reinforcement fibers may be used for reinforcement including polymer, fiberglass, metal, cotton, other natural fibers, and the like. The sheet materials may include fabrics made with fibers such as glass, carbon, Kevlar, Nomex, aluminum, and the like, some saturated with a polymer such as polyester, vinyl ester, or epoxy for added strength, wear resistance, and resilience. The fibers within a reinforcement sheet may be aligned in one direction, in cross directions, randomly oriented, in curved sections, or in a three-dimensional (3-D) configuration to provide various mechanical properties, such as tearing tendency and differential tensile strength along different directions, among others.

The reinforcement layers may be laminated in the field using epoxy, various glues, or similar adhesives to create a thick laminate that will be stiffer than the sum of the individual reinforcement layers placed around structures. Different reinforcement layers may use sheets with fibers oriented in different directions, such as orthogonal directions, to further reinforce the SRW.

In various embodiments, multiple honeycomb laminates may be employed to further reinforce the SRW. Various layers in the SRW may be glued to each other to form one integral laminate wrap. In some embodiments, each layer in the SRW may be made from a different or same type of reinforcement sheet to develop different costs, performances, and mechanical properties for the SRW. For example, the outer layers may be made from thicker and tougher reinforcement sheets while the inner layers (closer to the structure) may be made from thinner and more flexible sheets to save material and installation or construction costs. Other variations in sheet layers are possible, such as fiber types and orientations, sheet materials, sheet material properties like chemical resistance, heat resistance, gas and fluid impermeability, and the like. SRW's made with such variations in reinforcement layers will exhibit different mechanical and chemical properties suitable for different applications, costs levels, and considerations such as environmental and public safety considerations.

The multi-layer embodiments may be pre-glued, pre-fabricated, and integrated prior to application to a structure or be integrated during the application to the structure.

In other various embodiments, some or all of the honeycomb or hollow-structure cells may be filled with one or more of a filler material, such as foam, concrete, polymer, and the like to displace the air within the cells and provide additional strength to the honeycomb or hollow-structure layer. The cell filling material may be injected or otherwise be placed within the cells after attaching the first honeycomb or hollow-structure skin layer, and then be covered and glued in place with the second skin layer. The skin layers themselves may be multi-layered in some embodiments.

In various embodiments, the reinforcement layers are formed around the structure to be reinforced, one layer at a time, using appropriate adhesives. Additional honeycomb layers or additional reinforcement layers may be formed around the structure to provide further strength for the structure. Alternatively, at least a first reinforcement sheet may be wrapped around the structure, then a layer of honeycomb may be glued or otherwise attached to the first reinforcement sheet, and finally at least a second layer of reinforcement sheet may be glued to the open face of the honeycomb. This process effectively constitutes the building of the honeycomb SRW in the field around the structure.

Those skilled in the art will appreciate that many other honeycomb type layers, hollow structures, or laminate structures are possible without departing from the spirit of the present disclosures. For example, the honeycomb cells may be constructed in any geometric form, such as rectangle, hexagon, and the like to serve the same purpose.

In some embodiments all or some of the different layers mentioned throughout this disclosure may have been manufactured as a single sheet layer. In other embodiments different reinforcement sheets may either be wrapped over the previous layer with or without adhesive materials to bond the two adjacent layers together.

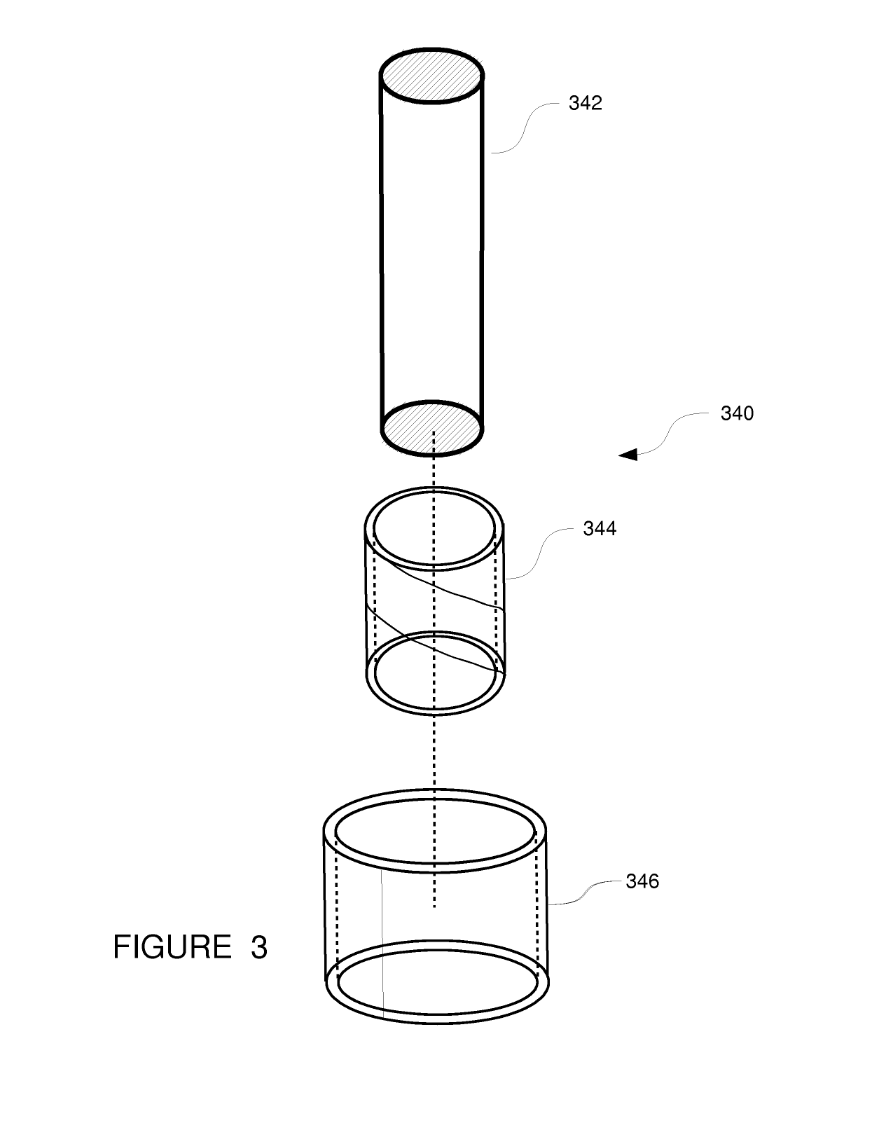

FIG. 3 shows another example column reinforcement using multiple overlapping shell segments. In such embodiments a space may be left between two or more reinforcement sheets in addition to or instead of the space between the first reinforcement sheet and the structure and one or all spaces may be filled, partially or completely, with one or more kinds of filler material. In various embodiments, a solid or a hollow structure or a pipe, such as column 342, is reinforced using multiple external reinforcement shell segments 344, 346, each shell segment constructed in a manner similar to that described above. The space between column 342 and reinforcement shell segment 344 and/or the space between reinforcement shell segment 344 and reinforcement shell segment 346 may be partially or completely filled with filler materials. In other embodiments the number of overlapping reinforcement shell segments may be in excess of two.

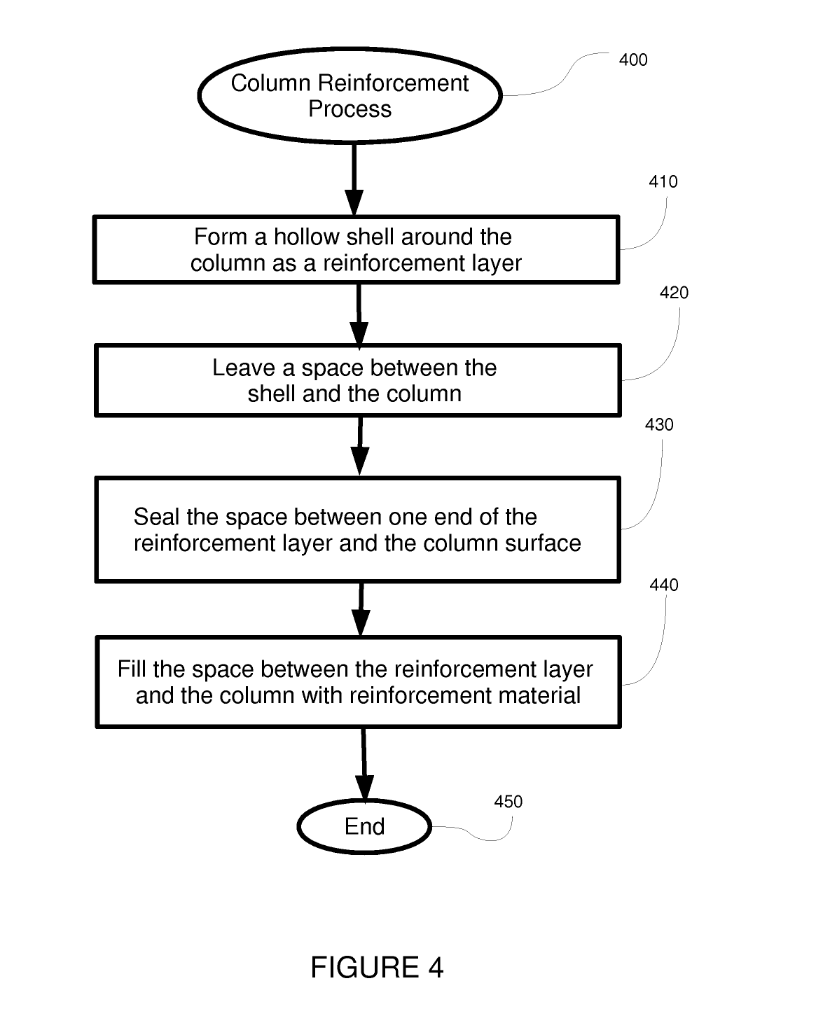

FIG. 4 shows an example process of reinforcing a column using a reinforcement sheet. Process 400 proceeds to block 410 where a reinforcement sheet is wrapped around a structure to be reinforced, such as a host column, pile or pipe. As described above, different types of reinforcement sheets may be used in constructing the SRW and the reinforcement shell. The reinforcement sheet may be wrapped in a non-overlapping spiral fashion or just as a ring to form a desired length for the reinforcement shell. The process proceeds to block 420.

At block 420, an optional space is left between the reinforcement layer and the surface of the structure. The process proceeds to block 430.

At block 430, one end of the space formed from the reinforcement sheet around the host column is sealed.

At block 440, the space created between the reinforcement layer and the host column is filled with a reinforcing material such as resin, concrete, grout, and the like. The process proceeds to block 450.

At block 450, the process terminates.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A method of reinforcing a structure, the method comprising:
forming at least one semi-rigid elastically-deformable fiber-based reinforcement-sheet into a reinforcement layer partially or completely surrounding the structure, wherein there is a space or gap between the reinforcement layer and a surface of the structure; and
filling the space or gap between the reinforcement layer and the surface of the structure with a reinforcing material.

2. The method of claim 1, further comprising creating a groove in the structure and deploying a rebar within the groove or deploying a rebar within the space, or both.

3. The method of claim 1, wherein shear studs are welded or bolted to the surface of the structure or steel rebars are added within the space and shear studs are welded or bolted to the surface of the structure.

4. The method of claim 1, wherein the reinforcement layer comprises at least one overlapping, or non-overlapping reinforcement sheets, or both.

5. The method of claim 1, wherein multiple reinforcement sheets are formed around a same part of the structure with a space between at least two of the overlapping reinforcement sheets and wherein the space between the at least two reinforcement sheets is filled, at least partially, with reinforcing material.

6. The method of claim 1, wherein multiple overlapping reinforcement-sheets form at least a part of the reinforcement layer and at least two of the overlapping reinforcement sheets are adhesively attached together.

7. The method of claim 1, wherein the structure is one of a column, a pile, a pole, a pipe, and a beam and is made of one of concrete, metal, wood, plastics, and masonry.

8. The method of claim 1, wherein the reinforcement sheet is a Fiber Reinforced Polymer (FRP).

9. The method of claim 1, wherein the reinforcement sheets are pre-preg and pre-cured.

10. The method of claim 1, wherein the structure is at least partially submerged in water or is at least partially under ground.

11. The method of claim 1, wherein the reinforcement sheets are prefabricated or are resin saturated and cured on site before formation into reinforcement layer, or both.

12. The method of claim 1, wherein the reinforcement-sheets are pre-saturated with resin or epoxy configured to be activated to cure with Ultra Violet (UV) light or water or the reinforcement-sheets are pre-preg and pre-cured.

13. A method of reinforcing a structure, the method comprising:
constructing multiple fiber-based reinforcement shell segments around a part of the structure at a working position, wherein there is a gap between the fiber-based reinforcement shell segments and the structure;
pushing each of the multiple reinforcement shell segments away from the working position along a direction in which the structure extends;
coupling each of the multiple reinforcement shell segments to the previous one to create a single solid shell around the structure from the multiple reinforcement shell segments; and
filling the gap, partially or completely, with a reinforcing material.

14. The method of claim 13, wherein constructing each of the multiple reinforcement shell segments comprises forming a continuous wall, by at least one semi-rigid elastically-deformable fiber-core reinforcement-sheet, around at least a part of the structure.

15. The method of claim 14, wherein the reinforcement-sheet is pre-cured Fiber Reinforced Polymer (FRP).

16. The method of claim 13, wherein shear studs are welded or bolted to a surface of the structure; or a steel rebar is added within the gap and shear studs are welded or bolted to the surface of the structure; or a groove is created in the structure and a rebar is deployed within the groove.

17. The method of claim 14, wherein the reinforcement-sheets are pre-saturated with resin or epoxy, configured to be activated to cure with Ultra Violet (UV) light or water or the reinforcement-sheets are pre-preg, pre-cured, and pre-formed.

18. The method of claim 14, wherein multiple reinforcement-sheets are used to construct a reinforcement shell segment around the structure such that there is a space between at least two of the reinforcement-sheets and the space between the at least two reinforcement-sheets is filled, at least partially, with reinforcing material or at least two of the overlapping reinforcement-sheets are adhesively attached together, or both.

19. The method of claim 13, wherein the space between one end of the reinforcement shell and the structure is sealed to prevent reinforcing material from escaping the space between the reinforcement shell and the structure.

20. A method of constructing a semi-rigid enclosure around a structural element to contain and hold reinforcement material around the structural element, the method comprising:
forming at least one semi-rigid elastically-deformable fiber-based reinforcement-sheet into a shell surrounding the structural element, wherein there is a space between the formed shell and a surface of the structural element for holding the reinforcement material.

21. The method of claim 20, wherein the reinforcement-sheet is pre-cured Fiber Reinforced Polymer (FRP).

22. The method of claim 20, wherein the reinforcement-sheets are pre-saturated with resin or epoxy configured to be activated to cure with Ultra Violet (UV) light or water or the reinforcement-sheets are pre-preg and pre-cured.

23. The method of claim 20, wherein multiple overlapping semi-rigid enclosures are formed around the structural component such that there is a space between at least two semi-rigid enclosures which may also hold reinforcement material.

24. The method of claim 20, wherein multiple overlapping reinforcement-sheets form the semi-rigid enclosure and at least two of the overlapping reinforcement-sheets are adhesively attached together.
